(19) United States
(12) Patent Application Publication
(10) Pub. No.: US 2007/0102375 A1
(43) Pub. Date: May 10, 2007

(54) Folder rack

(76) Inventor: Jean V. Rittmann, Everett, WA (US)

Correspondence Address: Jean V. Rittmann, 2016 Broadway Ave., Everett, WA, 98201-2318, US

(21) Appl. No.: 11/268,055

(22) Filed: Nov. 8, 2005

(51) Int. Cl. B42F 17/00

(52) U.S. Cl. 211/11

(57) ABSTRACT

This invention is a backward-leaning folder rack having a plurality of side walls, a first floor, and a back wall. The side walls extend upwards and the back wall is upwards from the first floor. The side walls have a front edge and a rear edge. The first floor has a front portion and a rear portion. The first floor inclines rear-to-front at an angle (like 10 degrees) from level. Each compartment can be of a width 1.5″ or less to confine the panels of a folder together. The invention can be supported at that angle by holes for hanging it on a wall, by downward side, wall extensions, by a front panel and corner leg, or by a second floor attached to the first floor by a means (like leg extensions, front panel, and corner leg).

### CROSS-REFERENCE TO RELATED APPLICATIONS

Not Applicable

### STATEMENT REGARDING FED. SPONSORED RESEARCH OR DEVEL.

Not Applicable

### REFERENCE TO A MICROFICHE APPENDIX

Not Applicable

### BACKGROUND OF INVENTION

This invention relates to office equipment not elsewhere specified. More specifically, holder or file for paper document, substantially vertical. This invention also relates to desk trays.

File folder holders, up till now have substantially been either trays or level vertical racks. Prior art, like that in U.S. Pat. No. 5,575,396 by Ole F. Smed, granted Nov. 19, 1996, entitled MODULAR STORAGE UNIT, can change to either type. In his FIG. 2A shows a vertical file assembly, where folders are boxed in by five walls. Files must be lifted up and lowered into each compartment to insert or review contents. Debris and small papers can be hard to remove from the bottom of such deep/narrow compartments. It is hard to grab just one of many like-looking folders in such compartments.

Smed's FIG. 2B depicts his storage unit as a folder tray with vertically-stacked 5-walled compartments for files. Folders insert sideways. However, all but the top folder stacked in each compartment is visible. This is because folders fit back into the trays at different distances, which sometimes entirely hides all files below the top file. The rack requires pulling out each folder to observe contents. It is of benefit, with both rack types, to limit the number of folders in each compartment, so each folder is easier to find and access. If the number of files per compartment is limited, the space the rest of the compartment takes up is essentially wasted space. Such ‘wasted space’ adds up with many file rack compartments. Nowadays, every inch of desk and wall space in an office is valued.

With most folders, the panel sides are closed against each other by an outside source. This is done in many ways: Trays hold folders closed by gravity, because folders are laying down. Standard (one-fold, non-hanging) folders in file drawers are held together by the pressure of one folder pressed against another, and by the pressure of the drawer back or sliding divider. Vertical racks, like Smeds, hold folders by confining them front-to-rear within about a 2″ section. Vertical racks, like that in U.S. Des. Pat. No. 313,430 by Mel Evenson, granted Jan. 1, 1991, entitled DIAGONAL SORTER, is another example of a rack where folders could be held together by such confining. Because, in Evenson's Sorter, both ends of each compartment are open, papers have to be carefully lowered in, and can't be slid in sideways. This is because there is no rear/back end to stop folders from being pushed out the other end of the rack. With no back panel, sorted papers or folders would have to be lined up with nearly every insertion.

Contents of vertical racks must be accessed by lowering/lifting out contents: same as file drawers. But unlike file drawers, that lets one have clearance above the files to pull them out, immobile racks cannot be easy-accessed if placed directly above each other.

Vertical racks, like that in U.S. Des. Pat. No. 240,104 by Sven-Eric Jublin, granted Jun. 1, 1976, entitled COMBINED FILE AND DISPLAY RACK provide a back wall. This rack has 4-sided compartments. Literature, like magazines, provide a square-back binding, similar to books, which allows literature better to stand upright in such wide compartments. As the compartments are quite wide, if a folder were placed in a compartment alone it would slant to one side, bow, or flop fairly open.

Prior Art folders, like that of U.S. PTO application Ser. No. 11/147691, by (me) Jean V. Rittmann, filed Jun. 09, 2005, entitled FOLDER WITH A SIDE HINGE, is an example of a folder that lets one scoot papers in sideways, where the hinge/stop on the far side (connecting both folder panels) keeps papers from scooting out the other side of the folder, and papers tend to line up evenly in the folder. Rittmann's folder patent pending describes the extra sorting advantage of such folders in a backward-tilted tray. However, prior-art backward-leaning racks have only previously been designed for books, not folders. Book racks do not have compartments to confine the sides of a folder. They are also not deep enough to hold 12″ long standard folders.

Prior Art holes, for hanging a rack on a wall, are often elongated, and wider at the bottom, to allow a screw head to slip through the hole. They are made level with the top of the rack to fit against a wall, so a user can make the rack level with the wall. A rack is lowered to secure it on the screws.

### BRIEF SUMMARY OF THE INVENTION

This invention is a backward-leaning folder rack having a plurality of side walls, a first floor, and a back wall. The side walls each have a front edge and a rear edge. The first floor has a front portion and a rear portion. The side walls extend upwards from the first floor. The back wall is upwards from the first floors rear portion. The first floor inclines rear-to-front at an angle (like 10 degrees) from level. A compartment is formed by two proximal side walls, a first floor, and a back wall. Each compartment can be of a width 1.5″ or less to confine the panels of a folder together. The rack can be supported at that angle on a desk by downward side wall extensions, by a front panel and corner leg, or by a second floor attached to the first floor by a means (like leg extensions, front panel, and corner leg). Or the rack could be hung on a wall. The area under the angled rack can be a triangular compartment for supplies.

### ADVANTAGES OF THE INVENTION

Folders can be inserted sideways (or down/sideways) [FIG. 19], which takes little effort. Papers can be filed without grabbing folders. The tilt helps folders/papers line up neatly as they are filed. The rack improves and highlights the sorting advantage of Rittmann's FOLDER. Embodiments can be short enough to let one peek in any folder [FIG. 20]. A rack can be less-deep-than-folder-width, so folders folded edge sticks out beyond rack. This makes it easy to grab one folder (at the folded bottom corner) at a time. The rack can be used with standard folders.

All folders can be easily seen and individually grabbed [FIG. 21], so a rack can be stuffed full. This means a rack smaller than prior art can be used (for the same number of folders). Therein the rack takes up less space desktop (or on a wall) than prior art racks. Because filing can be done substantially sideways, several racks can be positioned one above another, in a fairly close arrangement. The triangular section beneath the rack can be used for storing small objects, like pens, tape, staplers, and more. Other benefits of the rack being shorter and not as deep/long as folders: the rack is more aesthetically pleasing. Because each compartment is narrow, folders stand fairly straight up and down. (Wider compartments, like 3″ wide, would allow folders to flop open (which looks sloppy) or bend (which shuts folders inhibiting insertion). Narrow compartments also helps hold standard folders so contents scoot in.

### BRIEF DESCRIPTION OF THE DRAWINGS

FIG. 1 is a LHS side perspective view of embodiment A.

FIG. 2 is a LHS view of embodiment A.

FIG. 3 is a RHS view of embodiment A.

FIG. 4 is a front view of embodiment A.

FIG. 5 is a back view of embodiment A.

FIG. 6 is a top view of embodiment A.

FIG. 7 is a bottom view of embodiment A.

FIG. 8 is the LHS perspective view of FIG. 1, W/P.A. folder & pencils.

FIG. 9 is substantially an unfolded view if made from flat material.

FIG. 10 shows a LHS embodiment, RHS perspective view.

FIG. 11 is a LHS perspective view of embodiment A.

FIG. 12 is a LHS view of embodiment A.

FIG. 13a is a RHS view of embodiment A.

FIG. 13b is a RHS view with a prior art folder in place.

FIG. 14 is a front view of embodiment A.

FIG. 15 is a back view of embodiment A.

FIG. 16 is a top view of embodiment A.

FIG. 17 is a bottom view of embodiment A (drawer in place).

FIG. 18 is the front perspective view of FIG. 1, W/P.A. folder & pencils.

FIG. 19 shows a user filing a paper, emb. A, front perspective view.

FIG. 20 shows a user peeking in a folder, emb. A, front perspective view.

FIG. 21 shows a user grabbing one folder, emb. A, front perspective view.

FIG. 22 shows several racks positioned one above another.

FIG. 23a shows a single compartment rack, LHS perspective view.

FIG. 23b shows the bottom view of the rack in FIG. 23a.

### DESCRIPTION OF THE NOTATIONS

2a a back wall
2b a back wall
3aw a side wall
3bw a right-side wall
3ax a side wall
3bx a side wall
3ay a side wall
3by a side wall
3az a side wall
3bz a side wall
4a a rear edge
4b a rear edge
5a an angular cavity
5b a drawer
6a a wall's outer-corner
6b a wall's outer-corner
7a a first floor
7b a rack bottom section
8a a second floor
8b a rack floor
φ9a a backward-tilted angle
φ9b a backward-tilted angle
10H1 a hole for hanging rack
10h2 a hole for hanging a rack
11a a front panel
20 a corner leg
12a a front portion
12b a front portion
13a a rear portion
13b a rear portion
44a a front edge
3bq a side wall
21 a front panel
1b a front section

### DETAILED DESCRIPTION OF THE INVENTION

### 1. Description of Embodiment A of the Invention

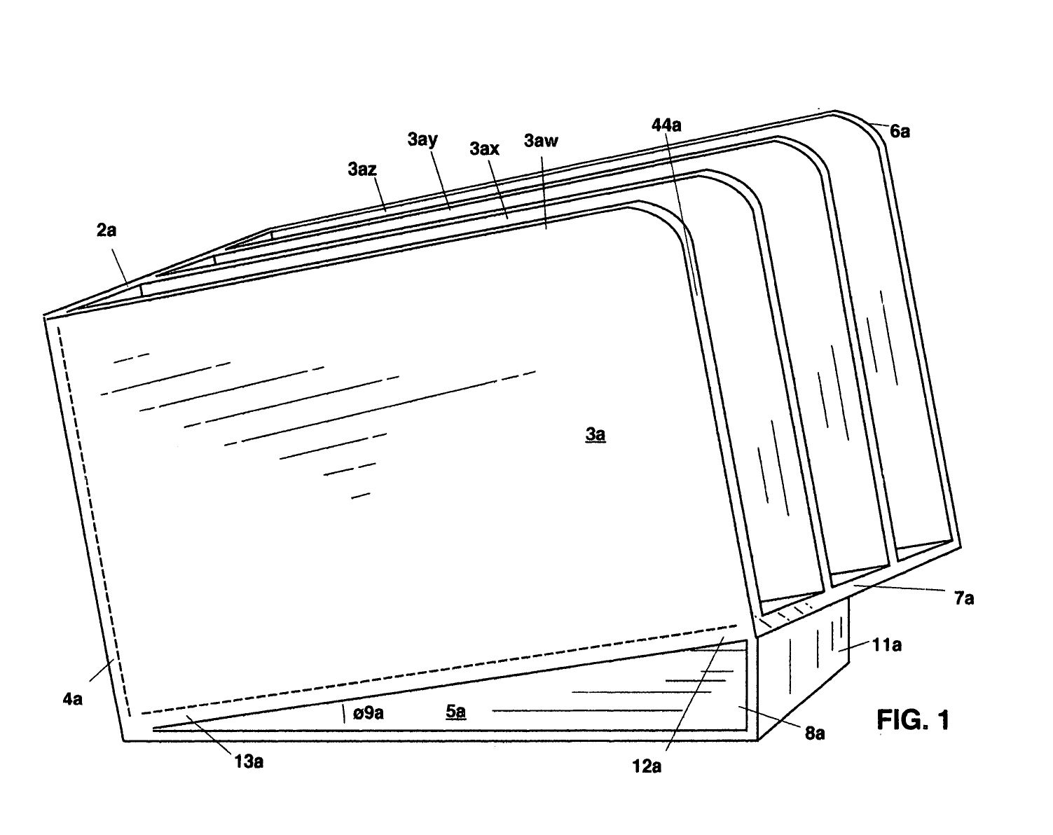

FIG. 1 is a LHS perspective view of embodiment A. Back wall 2a, left-side wall 3a, and a plurality (two or more) of substantially flat divider walls (side wall 3aw, side wall 3ax, side wall 3ay, and side wall 3az) are noted. The side walls have front and rear edges, like front edge 44a and rear edge 4a for wall 3aw. The embodiment shown is for standard-size folders/8.5×11″ papers. This embodiment has first floor 7a (noted at its front-most edge). First floor 7a's front portion 12a and a rear portion 13a are noted at their LHS edge. The side walls extend substantially upwardly from first floor 7a. Back wall 2a is substantially upward from first floor 7a's rear portion. Back wall 2a positions substantially at the rear edge of the side walls. Side walls 3aw and 3ax, back wall 2a, and first floor 7a define a compartment. Side walls 3ax and 3ay, back wall 2a, and first floor 7a define a compartment. Side wails 3ay and 3az, back wall 2a, and first floor 7a define a compartment.

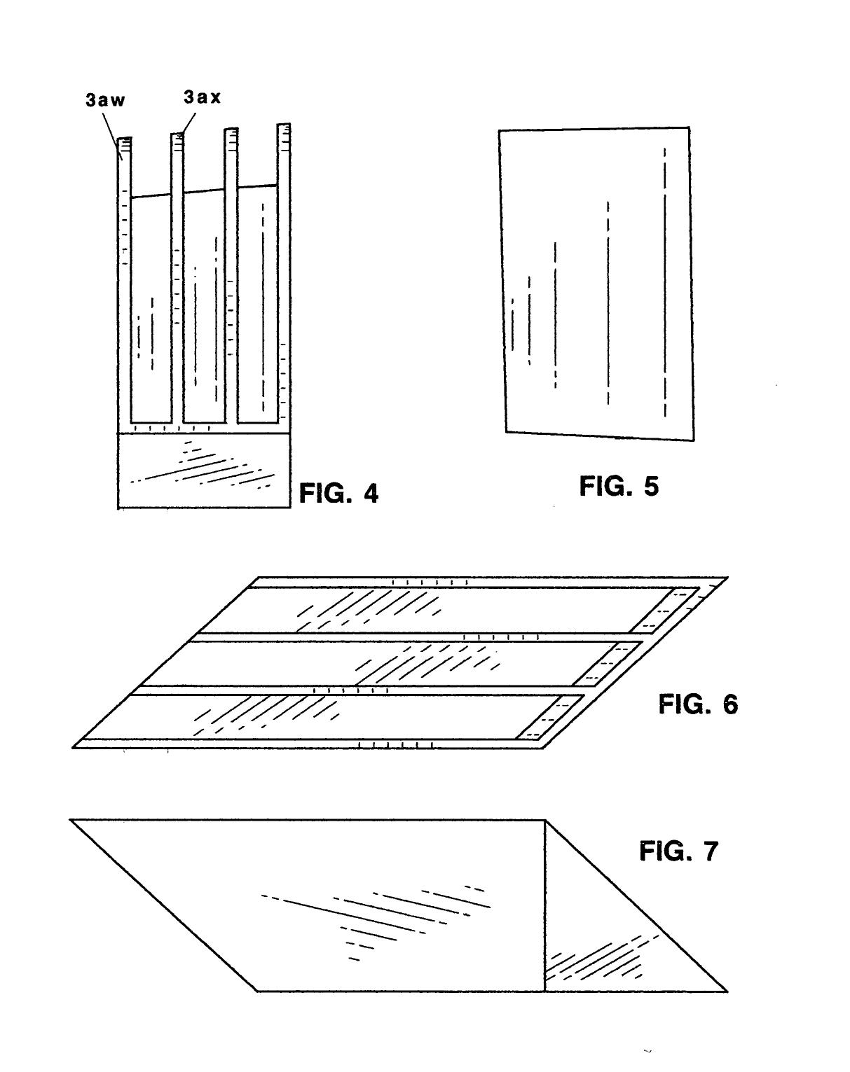

Each compartment is about 1.2″ wide, and has side walls substantially 6″ high and 10.5″ front-to-back long. Compartments are made narrow to keep folders from flopping wide open, or from bending, which would present an unkempt appearance. [This compartment width is more clearly shown in FIG. 4, noting side walls 3aw and 3ax.]

When in use, first floor 7a inclines rear-to-front, or back-to-front, at angle φ9a from level. This embodiment shows angle φ9a at substantially ten degrees (10°). The incline, or backward tilt of the rack, provides a bit of gravity for papers to slip into folders with ease and for keeping folders against the back wall. The angle makes the front of each compartment up from a desktop. So the angle, in combination with a compartments short (10.5″) length, lets one grab the bottom corner of a folder [FIG. 21]. The incline or tilt also provides a psychological security to a user, that papers and folders will stay secure in the rack.

Angular cavity 5a is substantially formed by first floor 7a, second floor 8a, and front panel 11a. First floor 7a inclines back-to-front at an angle of ten degrees from second floor 8a. In use, the bottom side of second floor 8a can be placed on a desktop. 6a notes a side wall outer-corner. In this embodiment, the side wall corners are rounded.

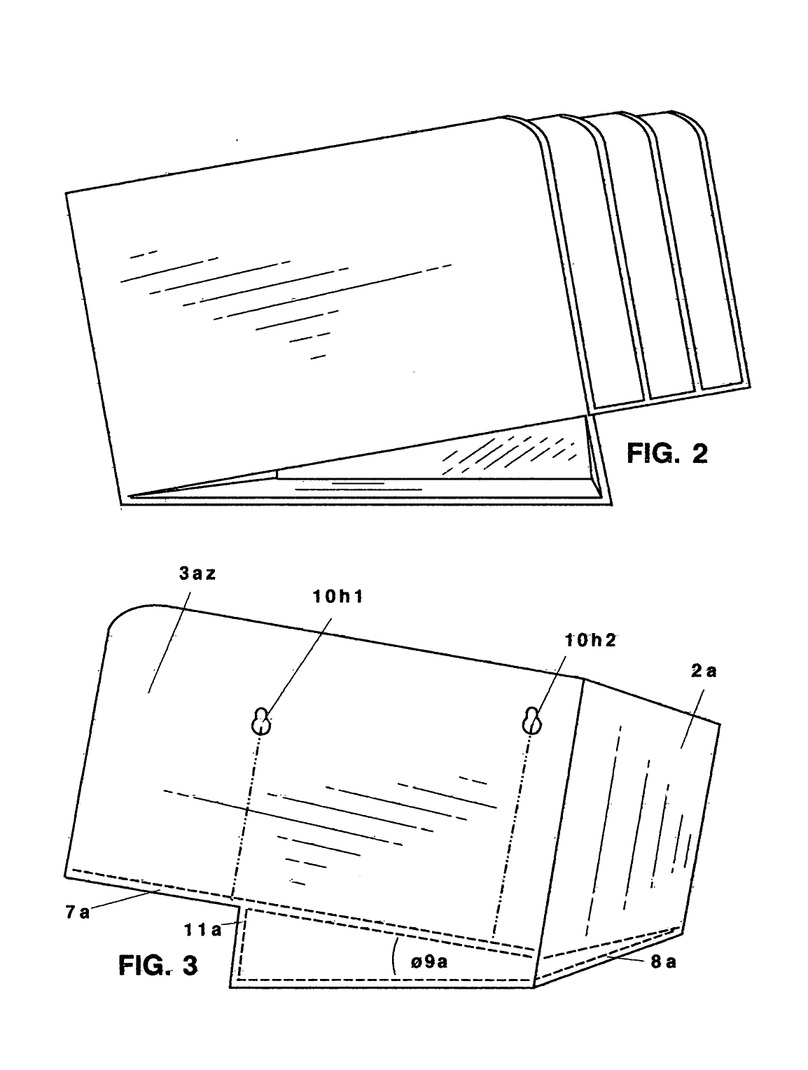

Other views of embodiment A are shown in FIGS. 2-8. FIG. 2 is a LHS view, FIG. 3 is a RHS view, FIG. 4 is a front view, FIG. 5 is a back view, FIG. 6 is a top view, and FIG. 7 is a bottom view, (all of embodiment A). FIG. 3's LHS view show holes 10h1 and hole 10h2, on side wall 3az, for hanging the rack on a wall. The holes shown are at different distances from the top edge of the embodiment so the rack compartments incline back-to-front at angle φ9a from level. Hole 10h1 positions angle φ9a closer to the first floor than hole 10h2. Using approximate measurements of this embodiment: with hole 10h2 5.5″ perpendicularly up from first floor 7a, and hole 10h2 5.2″ from hole 10h1, then hole 10h1 is 5.2″ sin(10°)=0.9″. 5.5″−0.9″=4.6″ 4.6″ is then the distance of 10h1 perpendicularly up from the first floor. Both holes position such that, when hung on a wall, the holes position substantially level, and the first floor inclines at a back-to-front at an angle from level.

Embodiment A may be sat on a desk or hung on a wall. FIG. 8 is the LHS perspective view of FIG. 1 shown with prior art folder, and with pencils in the angular cavity noted in FIG. 1. Overall dimensions of such an embodiment may be≅9.3″ high, 4.5″ wide, and 14.5″ deep (like if put in a rectangular box).

Referring back to FIG. 1 and FIG. 3, second floor 8a is fixedly attached to this rack embodiment by means of front panel 11a, a downward extension of RHS side wall 3az (the area beneath first floor 7a), and a downward extension of back wall 2a. A second floor attachment means could be just front panel 11a and back wall 2a. A second floor attachment means could be just front panel 11a and side wall 2a. Whichever, the back-most corner is substantially supported by the back-most corner of the first floor. The second floor has a bottom surface such that when the bottom surface is positioned on a level surface (like a desk or shelf), the second floor (with an attachment means to the rack) is of a size & shape to support the rack first floor at the 10° angle. Additional ‘feet’ (not shown) may be fixedly attached to the second floor's bottom side. Four feet, like couch legs, but as short as 1 mm, can keep an embodiment from wobbling on an uneven desktop. Another way of preventing ‘wobble’ would be a bottom side outer rim, like the bottom rim of a bucket.

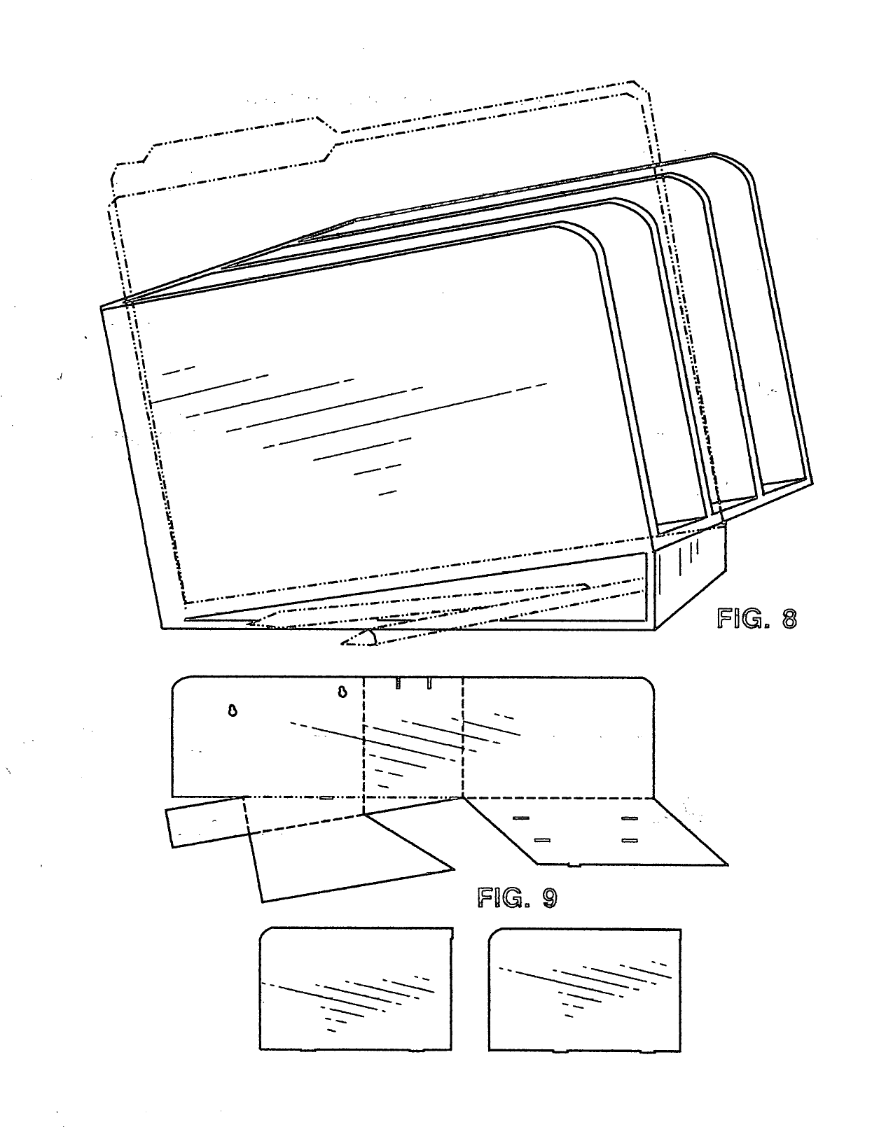

Drawings of A may not be entirely perfect, due to the odd angles. So FIG. 9 shows the embodiment A as substantially an unfolded view, if made from flat material. Tabs and slots are shown. When folded/assembled, tabs can position inside slots. Tabs can lock into slots in many unshown manners: like with frictional pressure, or with tabs having barbed ends. Not all planes/means of attachment are shown in the drawing.

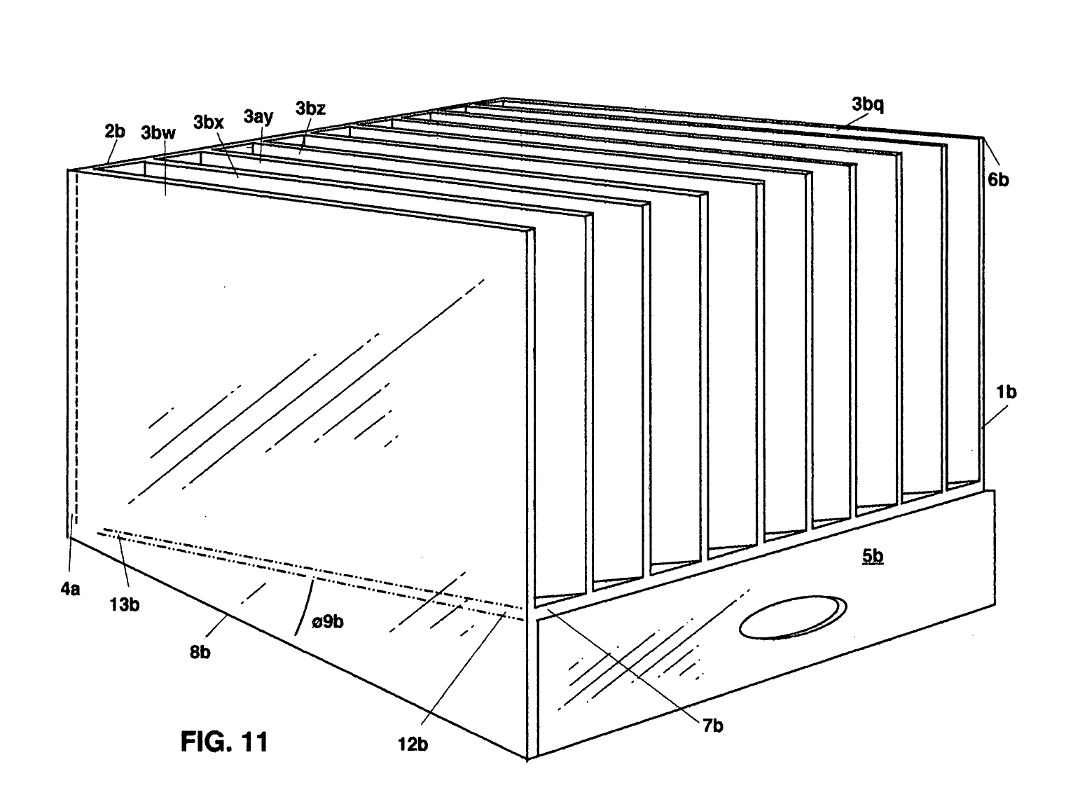

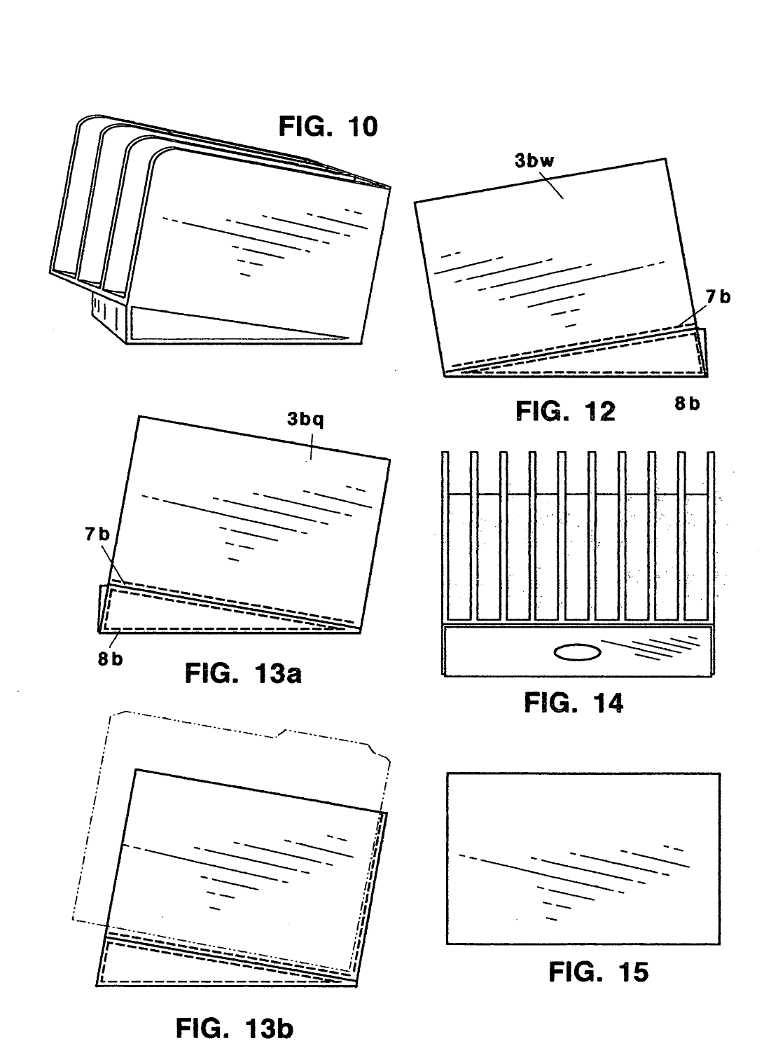

Embodiment A is drawn in FIG. 1 as an embodiment convenient for right-handed users. FIG. 10 shows a similar-to-FIG. 1, but left-hand-sided embodiment, front perspective view.

### 2. Description of Embodiment B of the Invention

FIG. 11 is a LHS perspective view of embodiment B. Front section 1b, back wall 2b, right-side wall 3bq, and a plurality of divider walls 3bw, 3bx, 3by, and 3bz are noted. The embodiment shown is for standard-size folders/8.5×11″ papers. In all views, for clarity, the drawer is shown slightly protruding from the rack. It can fit completely under the first floor, perhaps at the same angle as the side walls.

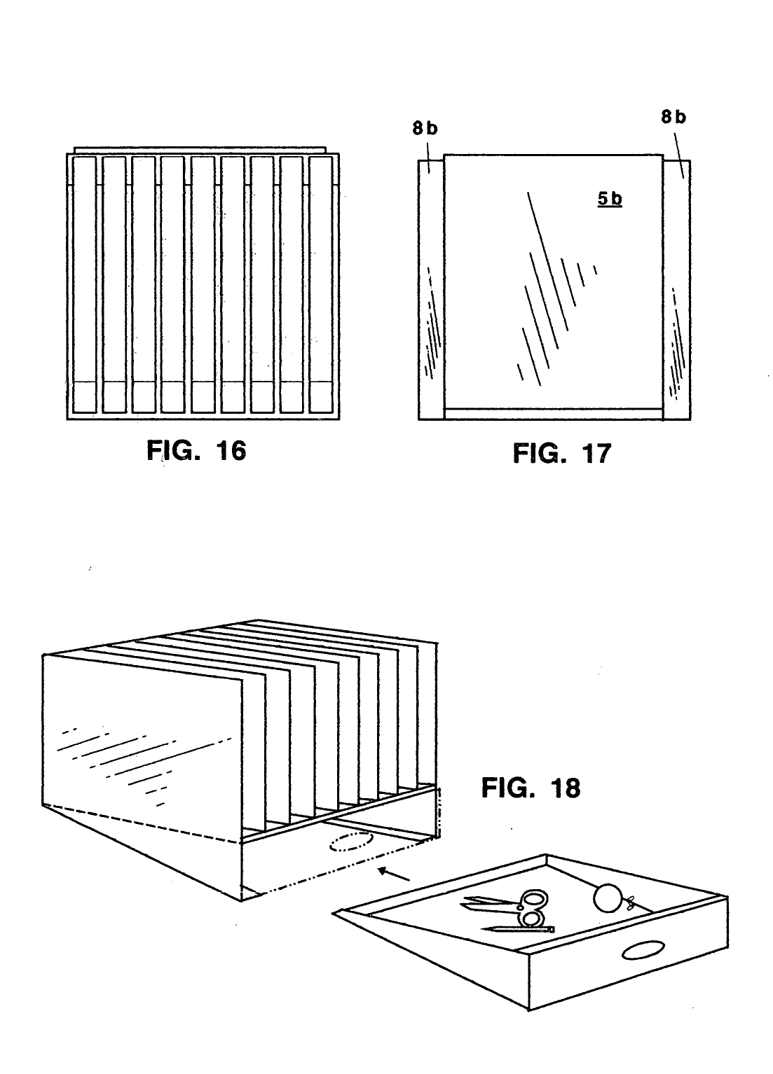

Drawer 5b (front shown), first floor 7b, and second floor 8b are noted. (8b is better seen in FIG. 17 as tracts for sliding drawer 5b) 6b notes side wall 3bq's front portion outer-corner, which is substantially square.

The first floor has front portion 12b and a rear portion 13b. The LHS edge of these portions noted. Angle φ9b is a backward-tilted angle. In this embodiment that angle is 12°.

Other views of embodiment B are shown in FIGS. 12-18. FIG. 12 is a LHS view. Wall thickness, like if walls are ⅛″ thick, are indicated with hidden (dotted) lines. FIG. 13a is a RHS view, FIG. 13b is a RHS view with a prior art folder in place, FIG. 14 is a front view, FIG. 15 is a back view, FIG. 16 is a top view, and FIG. 17 is a bottom view of embodiment B (drawer in place). Folder compartments are substantially 1.3″ wide, 6″ tall, and 10.5″ long. FIG. 18 is the LHS perspective view of FIG. 11, shown with a prior art folder, and office items in the pull-out tray.

Referring back to FIGS. 11, 12, 13a, and 17, second floor 8b is fixedly attached to first floor 7b by means of downward extensions of side walls 3bw and 3bq (not all notations shown in every view). Second floor 8b could just be the bottom edges of these side wall downward extensions. This second floor is a pair of rails to support the drawer substantially beneath the first floor.

The second floor could be a continuous bottom. Such a wide bottom alone would tend to bow/warp with thin-walled injection molding. It could be leveled by with downward extensions of more than two side walls (forming multiple front-facing compartments, or it could have feet (like described previously).

### 3. Common Specifications of the Invention

Compartment floors and walls may be ⅛″ thick, like if made of plastic, or much thinner if fabricated from metal.

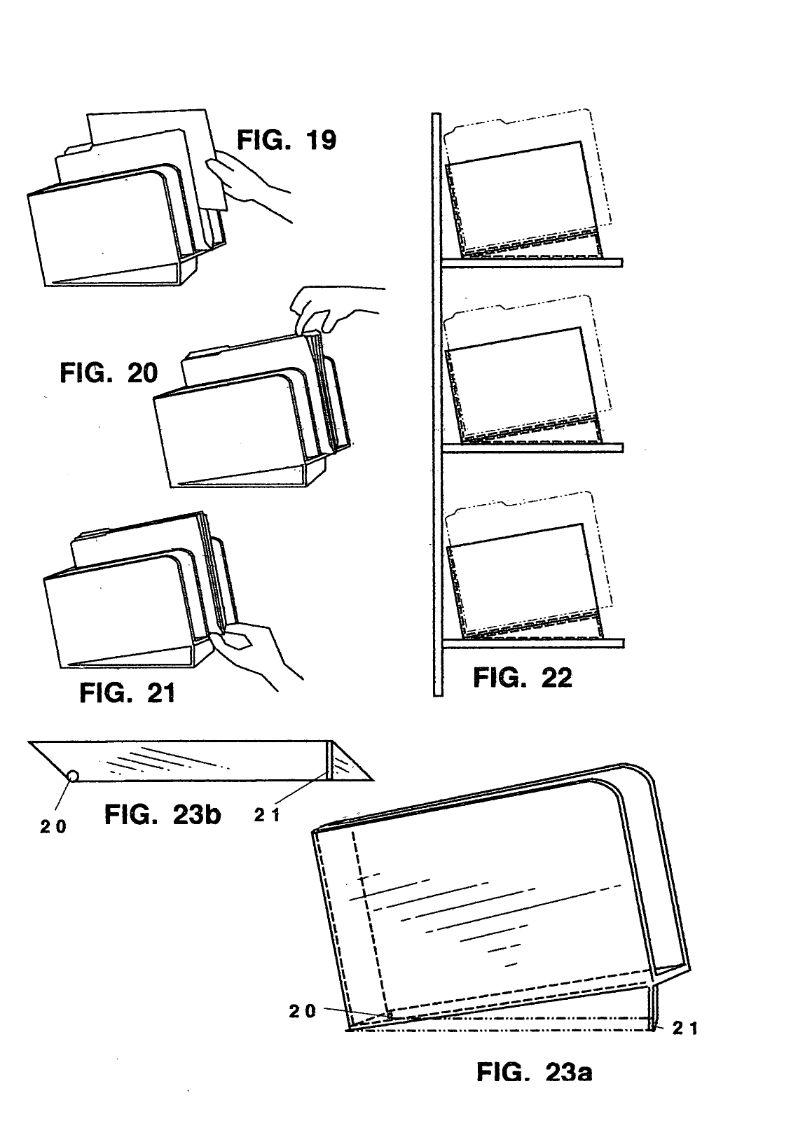

FIG. 19 shows a user filing a paper, embodiment A front perspective view. The size of the plurality of divider-side walls substantially defines the height/width of the rack's compartments. The embodiments shown may be 6″ tall and 10.5″ deep. Standard folders average 9.5″ tall. The compartment walls are shorter than most folders so one can peek in each folder to observe contents. This is shown in FIG. 20, which shows a user peeking in a folder, embodiment A front perspective view. But the walls are not much shorter as to let folders hang open much. Standard folders average 12″-long (in line with rack depth of 10.5″). The rack is shorter than folders, which lets folders protrude out the front of the rack. This makes it easy to grab the bottom folded corner of any folder, so only one folder is grabbed at once. FIG. 21 shows a user grabbing one folder (at the bottom corner) (from embodiment A) front perspective view. FIG. 22 shows several embodiment B racks positioned one above another; positioned by shelving. Racks can be stacked substantially vertically close because folders can be accessed sideways. Even if one prefers to scoot papers in down/sideways, curving a paper when inserting allows for such insertion even in such tight space. FIG. 23a shows a single compartment rack, LHS perspective view.

FIG. 23b shows the bottom view of the rack in FIG. 23a. Referenced in both figures, corner leg 20 supports the bottom towards-the-rear corner of the rack, so the rack is level on a tabletop. (The back-most triangular bottom corner of the first floor supports the back-most section of the rack, when tabletop.) Front panel 21 is substantially rectangular in front, perpendicular to the rack walls, to keep the front portion of the rack level on a tabletop. Both the front panel 21 and the corner leg 20 are unnecessary when such a rack is hung on a wall (at an angle). Multiple single-compartment racks may be attached together in a prior art method, like Smed's Unit, in other prior art ways, or in future art ways.

Shown are rack versions for folders for 8.5″×11″ papers. Alternate racks may be made for A size, legal size, and other size papers. Dimensions may be made proportional to the size of folders and papers.

The backward tilt of the racks shown are 10-12 degrees. The tilt could be less, like 5°, but this would provide negligible room for an angular cavity to store supplies. The backward tilt could be greater, like 20 degrees, but this makes viewing the top tabs of folders more difficult. Having a compartment width less than two inches or less than 1.5″ is needed to support folder sides.

### 4. Materials

A multitude of rigid materials may be used, including in combination, for all parts of any embodiment of my invention. Materials that may be used include, but are not limited to, plastic or metal. More specific materials might be injection molded acrylic resin or an embodiment fabricated from forming and spot welding plated steel. Embodiment A can even be folded/assembled from flat material like foam board or heavy-duty cardboard.

### 5. Other Possible Embodiments of the Invention

The back wall can be as little as a rod, or a plurality of rods, substantially extending the width of each compartment. A rod, like positioned 3″ or more up from a first floor, positioned substantially near the rear edge of the side walls, would prevent folders from sliding out the back of the rack.

### CONCLUSION

My tilted rack invention is a backward-leaning folder rack with at least one compartment having a floor, side walls, and a back wall. Each compartment can be of a width 1.5″ or less to confine the panels of a folder together. The backward angle can be 10 degrees.

Such a rack tilt produces not just an improved rack, but a new look. In person, embodiment A is a most bizarre—intriguing looking rack, which can excite a buyer. Others in the art may have felt a tilted rack could let papers and folders not come out together, but with narrow compartments, this is not so. Book racks, with wide open sideways space, are unworkable, because folder sides must always be held closely together if folder is to be stood upright. Most prior art folder racks are substantially similar, having 3, 4, or 5 flat walls to contain folders, none tilted backward. My rack is the first to provide a multi-improved compartment. Access to a folders bottom corner is new since a backward tilt lifts the front corner off a table. A compartment can also allow for increased folder density without reducing folder access. The angular space beneath the rack first floor provides an exciting new space to store office items (exciting like angular shelves/closets or an office space built beneath a staircase).

I claim:

1. A folder rack having:
a plurality of side walls; said side walls having front and rear edges;
a first floor;
said side walls extending substantially upwardly from said first floor;
a back wall, said back wall substantially upward from said first floor;
said back wall positioned substantially near the rear edge of said side walls;
wherein said side walls, said back wall, and said floor define a compartment;
each said compartment being less than two inches wide;
said first floor having a front portion and a rear portion, such that, in use,
said first floor inclines back-to-front at an angle from level, said angle being at least five degrees.

2. The rack, according to claim 1, wherein said angle being between seven and twenty degrees.

3. The rack, according to claim 1, wherein a said compartment being less than 1.5 inches wide.

4. The rack, according to claim 1, wherein said plurality of walls being more than two; each compartment of said rack being less than 1.5 inches wide, and said angle being more than seven degrees.

5. The rack, according to claim 1, further including two holes on a said side, for hanging said rack; said holes positioning such that, when said rack is hung on a wall, the holes position substantially level and the first floor inclines at a back-to-front at said angle from level.

6. The rack, according to claim 5, wherein said angle being greater than seven degrees.

7. The rack, according to claim 1, further including a second floor, said second floor fixedly attached to said rack by a means.

8. The rack, according to claim 7, wherein said second floor having a bottom surface; such that when said bottom surface is positioned on a level surface, said second floor with said means is of a size and shape to support said rack first floor at said angle.

9. The rack, according to claim 8, wherein said means being a front panel and a back corner leg.

10. The rack, according to claim 8, wherein said means being downward extensions of at least two said side walls.

11. The rack, according to claim 10, said at least two side walls having bottom edges, wherein said second floor is at least said bottom edges.

12. The rack, according to claim 10, further including a drawer; wherein said second floor being at least a pair of rails to support said drawer substantially beneath said first floor.
